(19) United States
(12) Patent Application Publication
(10) Pub. No.: US 2026/0328287 A1
(43) Pub. Date: Oct. 22, 2026

(54) TRANSMISSION DEVICE

(71) Applicant: MUSASHI SEIMITSU INDUSTRY CO., LTD., TOYOHASHI-SHI, AICHI (JP)

(72) Inventor: Takashi ATSUMI, TOYOHASHI-SHI, AICHI (JP)

(21) Appl. No.: 19/117,476

(22) PCT Filed: Oct. 7, 2022
(86) PCT No.: PCT/JP2022/037708

§ 371 Date: Apr. 1, 2025

(51) Int. Cl. F16H 63/34; F16H 57/02; F16H 57/021; F16H 57/037

(52) U.S. Cl. CPC F16H 63/3425; F16H 57/021; F16H 57/037; F16H 2057/02034; F16H 2057/02052

(57) ABSTRACT

A transmission device that can remove air from a support portion of a pawl shaft while maintaining strength of the support portion. One aspect of disclosure is a transmission device including a transmission mechanism, a parking lock mechanism, and a gear case. The parking lock mechanism includes a pawl shaft and a parking pawl swingable about the pawl shaft. The gear case includes a first support portion supporting a first end portion of the pawl shaft and a second support portion supporting a second end portion of the pawl shaft and having higher rigidity than the first support portion does against lock load from the parking pawl. The pawl shaft has a communication hole reaching from the first end portion to the second end portion. The second support portion includes an insertion port, a bottom face, and a groove extending from the bottom face to the insertion port.

### TECHNICAL FIELD

The present disclosure relates to a transmission device,

### BACKGROUND ART

In a parking lock mechanism provided in a transmission device, a pawl shaft serving as a rotation shaft of a parking pawl is supported by a support portion provided in a gear case. A load is generated on the pawl shaft in a radial direction in a state where the parking pawl locks an input shaft (see Patent Document 1).

Therefore, when a gap between the pawl shaft and the support portion is large, the parking pawl may be displaced due to the load, and parking lock may be insufficient. Therefore, it is necessary to minimize the gap between the pawl shaft and the support portion.

### PRIOR ART DOCUMENTS

### Patent Documents

Patent Document 1: Japanese Unexamined Patent Application Publication No. 2017-072203

### SUMMARY OF THE INVENTION

### Problems to be Solved by the Invention

In order to minimize the gap between the pawl shaft and the support portion, it is necessary to remove an air from the support portion when the pawl shaft is inserted into the support portion in assembly of the transmission device. The air can be removed from the support portion by providing a groove in the support portion, but strength of the support portion is reduced due to the groove.

An aspect of the present disclosure preferably provides a transmission device allowing removal of an air from a support portion of a pawl shaft while maintaining strength of the support portion,

### Means for Solving the Problems

An aspect of the present disclosure is a transmission device comprising a transmission mechanism having an input shaft, a parking lock mechanism, and a gear case that accommodates the transmission mechanism and the parking lock mechanism. The parking lock mechanism includes a pawl shaft having a shaft center parallel to a rotation shaft center of the input shaft, and a parking pawl that is swingable about the pawl shaft between a locked position, at which the parking pawl is engaged with the input shaft to restrict rotation of the input shaft, and an unlocked position, at which the parking pawl is disengaged from the input shaft.

The gear case includes a first support portion that supports a first end portion of the pawl shaft, and a second support portion that supports a second end portion of the pawl shaft opposite to the first end portion and that has greater rigidity than the first support portion does against a lock load received from the parking pawl when the parking pawl is at the locked position. The pawl shaft has a communication hole reaching from an end face of the first end portion to an end face of the second end portion. The first support portion is in contact with the first end portion over an entire circumferential direction. The second support portion includes an insertion port, into which the second end portion is inserted, a bottom face facing the end face of the second end portion in an axial direction of the pawl shaft, and a groove extending from the bottom face to the insertion port.

With such a configuration, the air in the first support portion is sent into the second support portion by the communication hole of the pawl shaft. Further, the air in the second support portion is discharged to an outside of the second support portion through the groove of the second support portion. Accordingly, when the pawl shaft is inserted into the first support portion and the second support portion, the air can be removed from the first support portion and the second support portion.

Further, by providing the groove only in the second support portion, which has high rigidity against the lock load received from the pawl shaft, of the first support portion and the second support portion, the strength can be maintained in each of the first support portion and the second support portion.

In an aspect of the present disclosure, when viewed in the axial direction of the pawl shaft, a straight line connecting the shaft center of the pawl shaft and a center of the groove may intersect a direction of the lock load. With such a configuration, it is possible to suppress a decrease in the strength of the second support portion due to the groove.

In an aspect of the present disclosure, the parking lock mechanism may include a torsion spring that is wound around the pawl shaft and that biases the parking pawl toward the unlocked position. The torsion spring may be disposed on a side opposite to the first support portion with the parking pawl interposed therebetween. The first support portion may have a boss protruding from an inner face of the gear case and a collar inserted into the boss.

With such a configuration, it is possible to increase the strength of the first support portion, which is closer to the parking pawl than the second support portion is due to the presence of the torsion spring. That is, it is possible to increase the strength of the first support portion receiving a larger load from the parking pawl.

### BRIEF DESCRIPTION OF THE DRAWINGS

FIG. 1 is a schematic right side view of a transmission device according to an embodiment in a state in which a second case is removed.

FIG. 2 is a schematic cross-sectional view taken along the line II-II in FIG. 1.

FIG. 3 is a schematic left side view of the transmission device of FIG. 1 in a state in which a first case is removed.

FIG. 4 is an enlarged view of surroundings of a parking lock mechanism in FIG. 3.

FIG. 5 is a schematic cross-sectional view taken along the line V-V in FIG. 3.

FIG. 6 is an enlarged view of surroundings of a pawl shaft in FIG. 2.

FIG. 7 is a schematic left side view of the second case of FIG. 3.

FIG. 8 is a schematic right side view of the first case of FIG. 1.

### EXPLANATION OF REFERENCE NUMERALS

1 ... transmission device, 2 ... transmission mechanism, 3 ... gear case, 3A ... first case, 3B ... second case, 3C ... fastener, 3D ... fastening hole, 3E ... support portion proximity region, 5 ... parking lock mechanism, 21 ... input gear, 31 ... breather chamber, 31A ... first chamber, 31B ... second chamber, 31C ... spare chamber, 31D ... communication portion, 34 ... first support portion, 35 ... second support portion, 37 ... reinforcement portion, 51 ... pawl shaft, 52 ... parking pawl, 53 ... torsion spring, 212 ... input shaft, 341 ... boss, 342 ... collar, 343 ... first bottom face, 351 ... insertion port, 352 ... second bottom face, 353 ... groove, 511 ... first end portion, 511A ... end face, 512 ... second end portion, 512A ... end face, 513 ... communication hole, 521 ... engagement portion

### MODE FOR CARRYING OUT THE INVENTION

Hereinafter, embodiments, to which the present disclosure is applied, will be described with reference to the drawings.

### 1. First Embodiment

### 1-1. Configuration

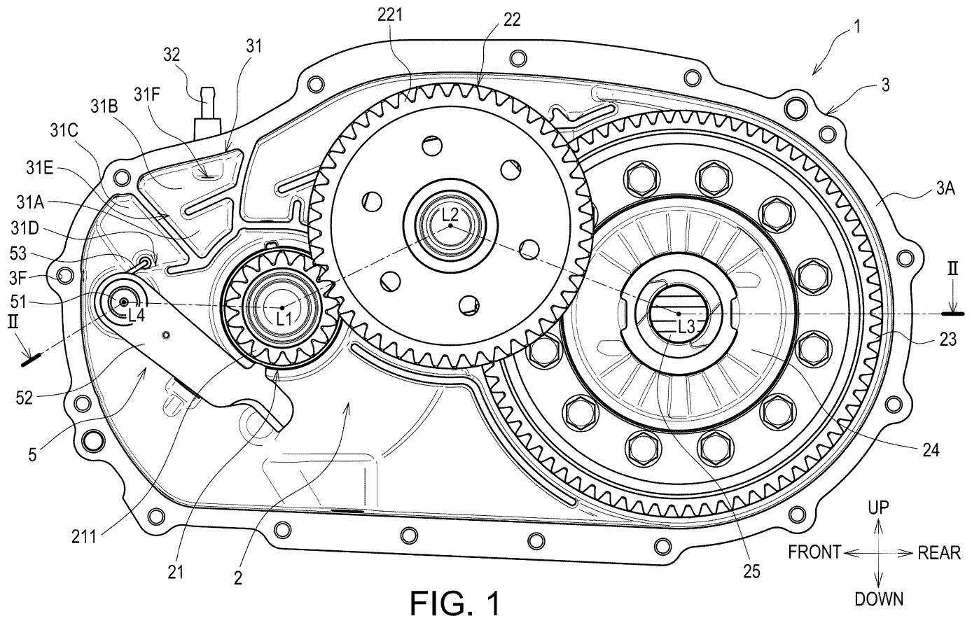

A transmission device 1 illustrated in FIG. 1 is a device that is installed in a vehicle and that transmits power of a drive source of the vehicle to wheels.

The transmission device 1 comprises a transmission mechanism 2, a gear case 3, and a parking lock mechanism 5. The transmission device 1 is installed in a vehicle in such an orientation that directions parallel to a rotation shaft center L1 of an input gear 21 of the transmission mechanism 2 are left-right directions, and a direction, in which the input gear 21 is disposed with respect to a ring gear 23, is a front direction.

### <Transmission Mechanism>

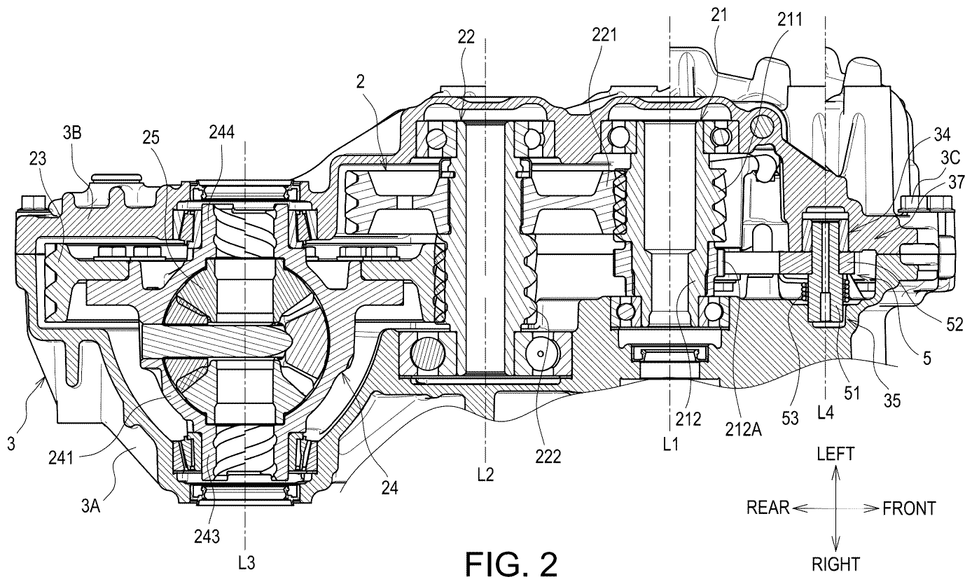

As illustrated in FIG. 2, the transmission mechanism 2 comprises the input gear 21, a counter gear 22, the ring gear 23, a differential case 24, and a differential mechanism 25.

### <Input Gear>

The input gear 21 is an external gear that is coupled to a motor (not illustrated) in a driving manner and that causes axial rotation using a driving force of the motor.

The rotation shaft center L1 of the input gear 21 is parallel to the left-right directions. The input gear 21 comprises a gear portion 211 and an input shaft 212 concentrically coupled to the gear portion 211. The input shaft 212 is a shaft portion, to which the driving force of the motor is input. The input shaft 212 comprises a parking gear 212A.

### <Counter Gear>

The counter gear 22 has a rotation shaft center L2 parallel to the rotation shaft center L1 of the input gear 21.

The rotation shaft center L2 of the counter gear 22 is located posterior to the rotation shaft center L1 of the input gear 21 and above the rotation shaft center L1 of the input gear 21 and a rotation shaft center L3 of the ring gear 23 (see FIG. 1). The counter gear 22 comprises a first gear 221 and a second gear 222.

The first gear 221 is an external gear that meshes with the input gear 21. The second gear 222 is an external gear that meshes with the ring gear 23. The second gear 222 has an outer diameter smaller than that of the first gear 221 and is disposed concentrically with the first gear 221. The second gear 222 is disposed on a right side of the first gear 221.

### <Ring Gear>

The ring gear 23 is an external gear having the rotation shaft center L3 parallel to the rotation shaft center L1 of the input gear 21. The rotation shaft center L3 of the ring gear 23 is positioned posterior to the rotation shaft center L2 of the counter gear 22. The ring gear 23 rotates the differential case 24 using a rotational force transmitted from the counter gear 22.

### <Differential Case>

The differential case 24 is fixed to the ring gear 23 and rotates about the rotation shaft center L3 of the ring gear 23 together with the ring gear 23. The differential case 24 comprises a differential mechanism accommodation portion 241, a first shaft portion 243, and a second shaft portion 244.

The differential mechanism accommodation portion 241 accommodates the differential mechanism 25. The first shaft portion 243 is a cylindrical portion, through which a first output shaft (not illustrated) coupled to the differential mechanism 25 is inserted. The second shaft portion 244 is a cylindrical portion, through which a second output shaft (not illustrated) coupled to the differential mechanism 25 is inserted.

### <Differential Mechanism>

The differential mechanism 25 is a known mechanism that distributes and transmits the rotation of the differential case 24 to the first output shaft and the second output shaft while differentially rotating the first output shaft and the second output shaft. The differential mechanism 25 is disposed inside the differential mechanism accommodation portion 241.

The differential mechanism 25 comprises two side gears coupled to the first output shaft and the second output shaft respectively, and two pinion gears that transmit the rotation of the differential case 24 to the two side gears.

The rotation shaft centers of the first output shaft and the second output shaft coincide with the rotation shaft center of the ring gear 23. The first output shaft and the second output shaft rotate in accordance with a rotation direction of the input gear 21 (that is, a rotation direction of the differential case 24) while differentially rotating,

### <Parking Lock Mechanism>

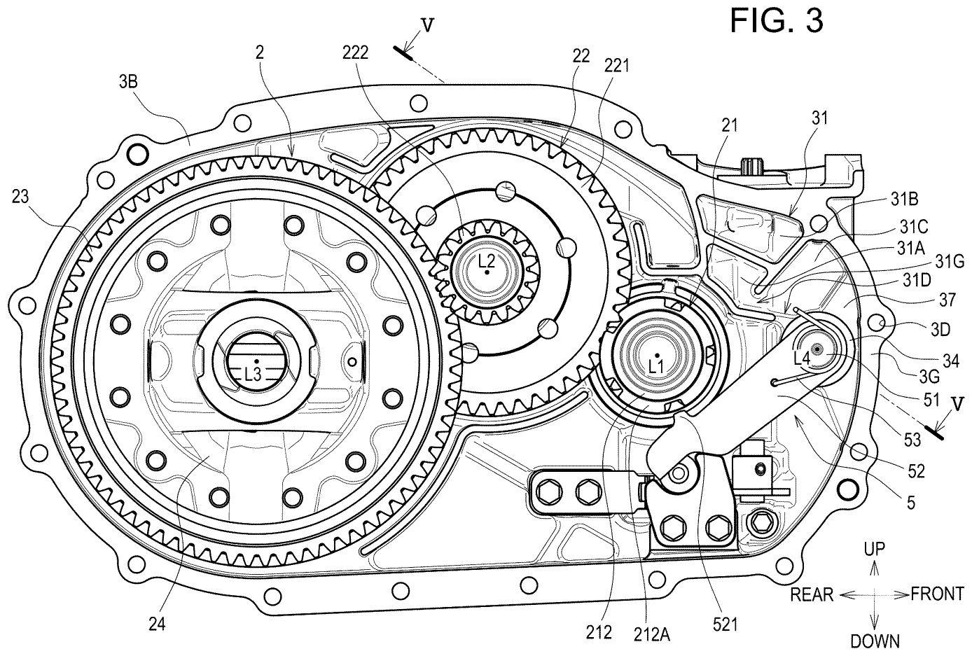

As illustrated in FIG. 3, the parking lock mechanism 5 comprises a pawl shaft 51, a parking pawl 52, and a torsion spring 53.

### <Pawl Shaft>

The pawl shaft 51 is a shaft portion having a shaft center L4 parallel to the rotation shaft center L1 of the input shaft 212. The pawl shaft 51 is supported by the gear case 3. The pawl shaft 51 is disposed between the input shaft 212 and an inner face of the gear case 3 (specifically, an inner face of a front wall 3G) intersecting front-rear directions in directions (that is, the front-rear directions) orthogonal to both an axial direction of the input shaft 212 and the vertical direction, and below a breather chamber 31.

### <Parking Pawl>

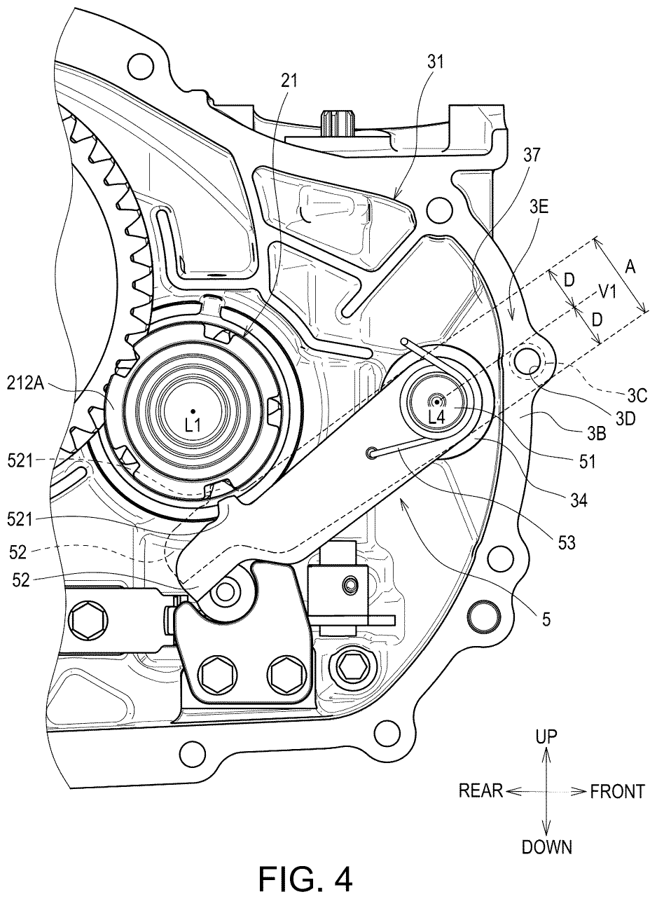

The parking pawl 52 is swingable about the pawl shaft 51 between a locked position indicated by a broken line in FIG. 4 and an unlocked position indicated by a solid line in FIG. 4. In the locked position, the parking pawl 52 is engaged with the parking gear 212A of the input shaft 212 to restrict the rotation of the input shaft 212. In the unlocked position, the parking pawl 52 disengages from the input shaft 212.

Specifically, the parking pawl 52 has an engagement portion 521 that engages with the parking gear 212A provided on the outer peripheral face of the input shaft 212 from a radially outer side of the input shaft 212 (specifically, from below).

### <Torsion Spring>

The torsion spring 53 is wound around the pawl shaft 51 and biases the parking pawl 52 toward the unlocked position. One end of the torsion spring 53 is fixed to a first case 3A. The other end of the torsion spring 53 is fixed to the parking pawl 52.

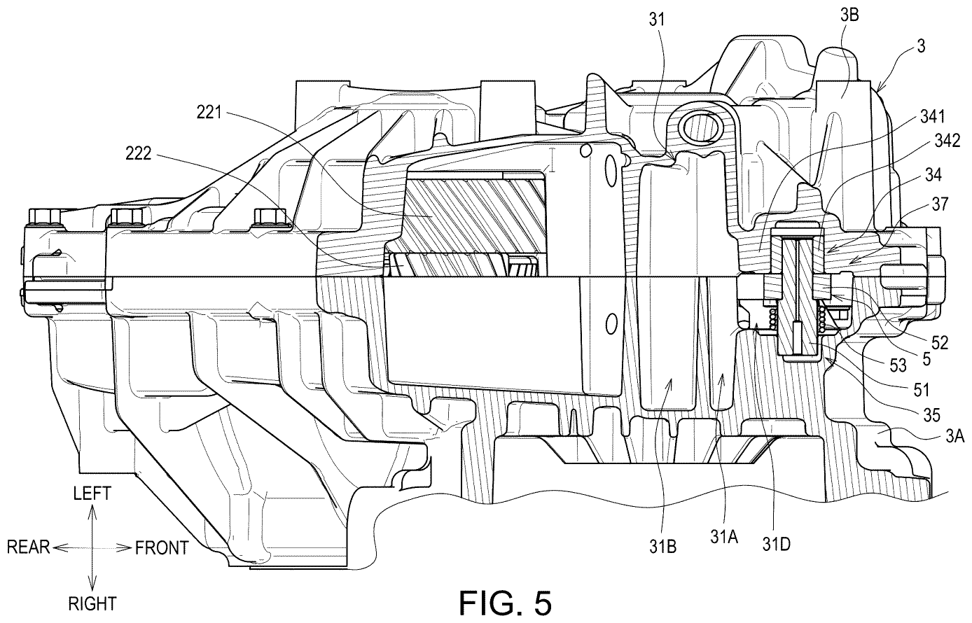

As illustrated in FIG. 5, the torsion spring 53 is disposed on a side opposite to a first support portion 34 of the gear case 3 with the parking pawl 52 interposed therebetween. That is, the torsion spring 53 is wound around a region of the pawl shaft 51 on a right side of the parking pawl 52.

The parking pawl 52 is moved to the locked position by an input in a lock direction from an actuator (not illustrated). Further, the parking pawl 52 returns to the unlocked position due to an input in the unlock direction from the actuator and the biasing force of the torsion spring 53.

### <Gear Case>

As illustrated in FIG. 2, the gear case 3 accommodates the transmission mechanism 2 and the parking lock mechanism 5. The gear case 3 comprises the first case 3A and a second case 3B that sandwich the transmission mechanism 2 and the parking lock mechanism 5 in the axial direction (that is, the left-right directions) of the input gear 21.

The first case 3A and the second case 3B are fixed to each other by a plurality of fasteners 3C (for example, bolts) in the left-right directions to form an internal space for accommodating the transmission mechanism 2 and the parking lock mechanism 5. In FIG. 2, illustration of a portion of the first case 3A accommodating a motor (not illustrated) as a drive source is omitted.

### <Breather Chamber>

As illustrated in FIG. 1, the gear case 3 comprises the breather chamber 31 and a breather pipe 32.

The breather chamber 31 is a space that provides a communication between the internal space, in which the transmission mechanism 2 and the parking lock mechanism 5 are accommodated, and an outside of the gear case 3. The breather chamber 31 separates oil mists from a breathing air containing the oil mists in the internal space of the gear case 3. The air, from which the oil mists have been separated, is discharged from the breather pipe 32 to the outside of the gear case 3.

As illustrated in FIG. 3, the breather chamber 31 comprises a first chamber 31A, a second chamber 31B, a spare chamber 31C, a communication portion 31D, a first communication port 31E (see FIG. 1), and a second communication port 31F (see FIG. 1).

As illustrated in FIG. 3, the first chamber 31A communicates with the internal space of the gear case 3 via the communication portion 31D. The first chamber 31A also communicates with the spare chamber 31C and the second chamber 31B. The communication portion 31D provides a communication between an inside of the breather chamber 31 and an outside of the breather chamber 31 in the internal space of the gear case 3.

The second chamber 31B is disposed above the first chamber 31A. The second chamber 31B is a chamber, into which the breathing air flows from the first chamber 31A. As illustrated in FIG. 1, the second chamber 31B communicates with the first chamber 31A via the first communication port 31E. The second chamber 31B communicates with the breather pipe 32 through the second communication port 31F.

The spare chamber 31C is disposed anterior to the first chamber 31A and the second chamber 31B. The spare chamber 31C is a chamber, into which part of the breathing air having passed through the communication portion 31D flows. The spare chamber 31C does not directly communicate with the second chamber 31B.

The first chamber 31A, the second chamber 31B, and the spare chamber 31C are disposed across the first case 3A and the second case 3B. Specifically, these chambers are constituted by ribs protruding from an inner face of the first case 3A intersecting the left-right directions and ribs protruding from an inner face of the second case 3B intersecting the left-right directions. The communication portion 31D is also provided across the first case 3A and the second case 3B.

The first communication port 31E and the second communication port 31F are provided only in the first case 3A and are not provided in the second case 3B. That is, the first communication port 31E and the second communication port 31F are disposed on a right side of the gear case 3. On the other hand, a communication port 31G between the first chamber 31A and the spare chamber 31C is disposed on a left side of the gear case 3 (see FIG. 3).

The breathing air in the gear case 3 passes through the communication portion 31D and flows into the spare chamber 31C and the first chamber 31A. The breathing air flowing into the first chamber 31A flows rightward, passes through the first communication port 31E, and flows into the second chamber 31B. The breathing air flowing into the second chamber 31B passes through the second communication port 31F and is discharged from the breather pipe 32 to the outside of the gear case 3. The oil mists contained in the breathing air are separated from the air in the process of flowing through the breather chamber 31.

### <First Support Portion, Second Support Portion, and Reinforcement Portion>

As illustrated in FIG. 5, the gear case 3 comprises the first support portion 34, a second support portion 35, and a reinforcement portion 37.

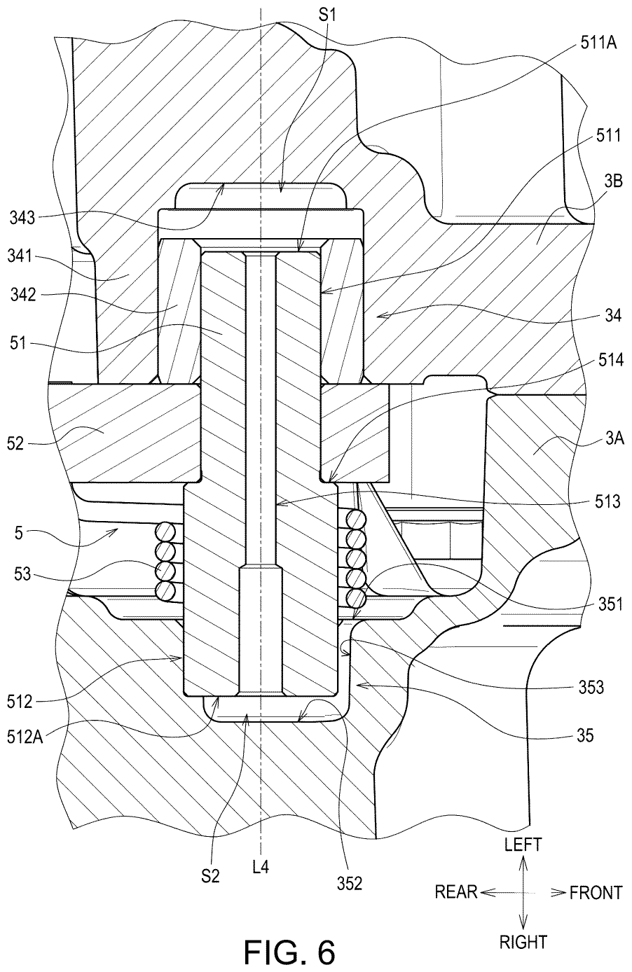

As illustrated in FIG. 6, the first support portion 34 supports a first end portion 511 (that is, a left end portion) of the pawl shaft 51. The first support portion 34 comprises a boss 341, a collar 342, and a first bottom face 343.

The boss 341 is a portion protruding rightward from an inner face of the second case 3B intersecting the left-right directions. The collar 342 is a cylindrical member press-fitted into the boss 341. The collar 342 is in contact with the first end portion 511 of the pawl shaft 51 over an entire circumferential direction.

A protruding end face (that is, a right end face) of the boss 341 is in contact with or in proximity to the parking pawl 52. The parking pawl 52 is in contact with a step 514 of the pawl shaft 51. The step 514 is a portion of the pawl shaft 51, at which a right region is enlarged in diameter compared with a left region. Instead of the protruding end face of the boss 341, a right end face of the collar 342 may be brought into contact with or in proximity to the parking pawl 52.

The parking pawl 52 is positioned by being interposed between the first support portion 34 and the step 514 in an axial direction of the pawl shaft 51. An outer diameter of the first end portion 511 of the pawl shaft 51 is smaller than an outer diameter of a second end portion 512 (that is, a right end portion) on an opposite side.

The first bottom face 343 faces an end face 511A of the first end portion 511 in the axial direction of the pawl shaft 51. The first bottom face 343 is disposed away from the end face 511A of the first end portion 511. That is, a first buffer space S1, in which the air is interposed, is formed between the first bottom face 343 and the first end portion 511.

The first buffer space S1 communicates with a communication hole 513 reaching from the end face 511A of the first end portion 511 to an end face 512A of the second end portion 512 of the pawl shaft 51. No flow path communicating with the outside of the first support portion 34 is connected to the first buffer space S1 other than the communication hole 513.

That is, neither gap nor groove is provided between the first end portion 511 and the collar 342 and between the collar 342 and the boss 341, respectively. The air in the first buffer space S1 can flow to the outside of the first support portion 34 only through the communication hole 513.

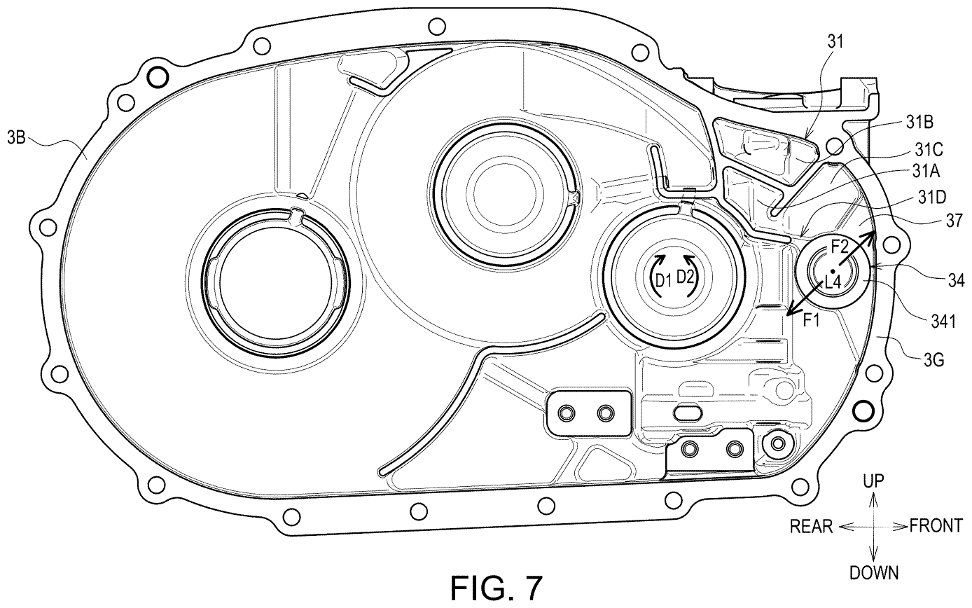

As illustrated in FIG. 7, the first support portion 34 (specifically, the boss 341) constitutes part of a wall of the breather chamber 31. Specifically, the first support portion 34 constitutes a lower wall of the spare chamber 31C and constitutes part of the communication portion 31D (that is, a side wall of the communication portion 31D).

Since the first support portion 34 constitutes part of the wall of the breather chamber 31 as described above, the pawl shaft 51 supported by the first support portion 34 inhibits oil from entering the breather chamber 31. Therefore, release of the oil from the breather pipe 32 is suppressed.

As illustrated in FIG. 6, the second support portion 35 supports the second end portion 512 of the pawl shaft 51. The second support portion 35 is configured by a recess provided by creating a hole in an inner face of the first case 3A intersecting the left-right directions. That is, second support portion 35 does not have a boss.

Therefore, when the parking pawl 52 is in the locked position, first rigidity and second rigidity against a first lock load F1 and a second lock load F2, which the second support portion 35 receives from the parking pawl 52, are larger than first rigidity and second rigidity against the first lock load F1 and the second lock load F2, which the first support portion 34 receives from the parking pawl 52, respectively.

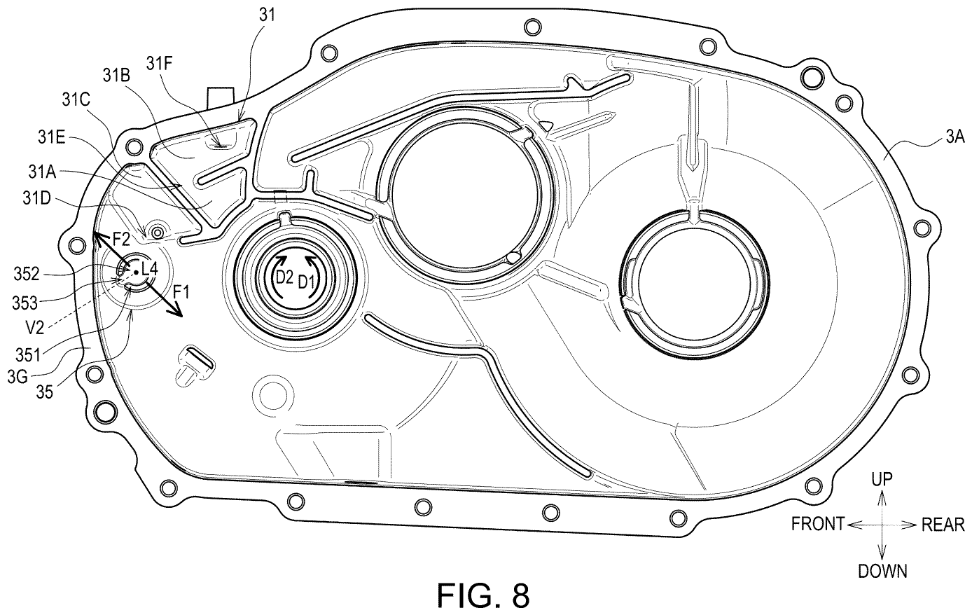

As illustrated in FIGS. 7 and 8, the first lock load F1 is a load generated in the first support portion 34 and the second support portion 35 when the input shaft 212 rotates in a first direction D1, and is a downward and rearward load. The first direction D1 is a direction, in which the input shaft 212 rotates when the vehicle moves forward.

The second lock load F2 is a load generated in the first support portion 34 and the second support portion 35 when the input shaft 212 rotates in a second direction D2 opposite to the first direction D1, and is a load in a direction opposite to the first lock load F1. The second direction D2 is a direction, in which the input shaft 212 rotates when the vehicle moves backward.

When both the first support portion 34 and the second support portion 35 have bosses protruding from the inner face of the gear case 3, the first rigidity and the second rigidity increase as outer diameters of the bosses increase.

As illustrated in FIG. 6, the second support portion 35 has an insertion port 351, a second bottom face 352, and a groove 353. The insertion port 351 is an opening, into which the second end portion 512 is inserted, and is provided in an inner face of the first case 3A intersecting the left-right directions. The second bottom face 352 faces the end face 512A of the second end portion 512 in the axial direction of the pawl shaft 51.

The second bottom face 352 is disposed away from the end face 512A of the second end portion 512. That is, a second buffer space S2, in which the air is interposed, is formed between the second bottom face 352 and the second end portion 512. The second buffer space S2 communicates with the communication hole 513 of the pawl shaft 51.

The groove 353 is a slit extending from the second bottom face 352 to the insertion port 351. The groove 353 provides a communication between the second buffer space S2 and the outside of the second support portion 35. The groove 353 is provided in a side wall, which covers the second end portion 512 from a radially outer side, partly in a circumferential direction.

The air in the second buffer space S2 is discharged to the outside of the second support portion 35 via the groove 353. The air in the first buffer space S1 is also discharged to the outside of the second support portion 35 through the communication hole 513, the second buffer space S2, and the groove 353.

As illustrated in FIG. 8, when viewed in the axial direction of the pawl shaft 51, an imaginary straight line V2 connecting the shaft center L4 of the pawl shaft 51 and the center of the groove 353 intersects with the directions of the first lock load F1 and the second lock load F2.

In addition, each of the first support portion 34 and the second support portion 35 is disposed closer to the inner face of the gear case 3 intersecting the front-rear directions (that is, the inner face of the front wall 3G) than the input shaft 212 is in the front-rear directions.

As illustrated in FIG. 7, the reinforcement portion 37 connects a support portion proximity region 3E and the first support portion 34 in a direction orthogonal to the axial direction of the input shaft 212 (that is, the radial direction of the pawl shaft 51).

The support portion proximity region 3E is a region (that is, part of the front wall 3G) in an outer frame of the gear case 3 opposite to the engagement portion 521 with the pawl shaft 51 interposed therebetween. In other words, the support portion proximity region 3E is a region in the outer frame of the gear case 3 where a distance to the first support portion 34 is smaller than a distance to the engagement portion 521.

As illustrated in FIG. 4, the reinforcement portion 37 protrudes from an inner face of the second case 3B intersecting the left-right directions and is integrated with the boss 341 of the first support portion 34 and the support portion proximity region 3E. Width of the reinforcement portion 37 in the vertical direction increases toward the front.

As illustrated in FIG. 4, the second case 3B has a plurality of fastening holes 3D, through which the fasteners 3C are inserted in the left-right directions, in the outer frame portion. The plurality of fastening holes 3D is provided at positions overlapping the plurality of fastening holes 3F (see FIG. 1) provided in the first case 3A.

When viewed in the axial direction of the input shaft 212, the fastener 3C exists in a specific region A, in which a distance D from an imaginary straight line V1 extending the center line of the parking pawl 52 at the locked position is equal to or less than half of a reference width of the parking pawl 52, in the support portion proximity region 3E.

The “reference width of the parking pawl 52” is a width (that is, a length in a direction orthogonal to the center line) of a portion of the parking pawl 52 including the shaft center L4 of the pawl shaft 51.

### 1-2. Effects

According to the embodiment described in detail above, following effects can be obtained.

(1a) The air in the first support portion 34 is sent into the second support portion 35 through the communication hole 513 of the pawl shaft 51. Furthermore, the air in the second support portion 35 is discharged to the outside of the second support portion 35 through the groove 353 of the second support portion 35. As a result, when the pawl shaft 51 is inserted into the first support portion 34 and the second support portion 35, the air can be removed from the first support portion 34 and the second support portion 35.

(1b) Of the first support portion 34 and the second support portion 35, the groove 353 is provided only in the second support portion 35 having high rigidity against the lock load received from the pawl shaft 51, so that the strength can be maintained in each of the first support portion 34 and the second support portion 35.

(1c) Since the imaginary straight line V2 connecting the shaft center L4 of the pawl shaft 51 and the center of the groove 353 intersects with the directions of the lock loads F1 and F2, it is possible to suppress a decrease in strength of the second support portion 35 due to the groove 353.

(1d) Since the first support portion 34 comprises the collar 342 inserted into the boss 341, the strength of the first support portion 34, which is closer to the parking pawl 52 than the second support portion 35 is because of the presence of the torsion spring 53, can be increased. That is, the strength of the first support portion 34 receiving a larger load from the parking pawl 52 can be increased.

### 2. Other Embodiments

Although the embodiments of the present disclosure have been described above, it is needless to say that the present disclosure is not limited to the above embodiments and can take various forms.

(2a) In the transmission device of the above embodiment, a straight line connecting the shaft center of the pawl shaft and the center of the groove may be parallel to the directions of the lock loads when viewed in the axial direction of the pawl shaft.

(2b) In the transmission device of the above embodiment, the torsion spring may be disposed on the left side of the parking pawl. The first support portion is not necessarily required to comprise the boss and the collar.

(2c) In the transmission device of the above embodiment, the gear case is not necessarily required to have the first case and the second case. That is, the gear case is not necessarily required to be constituted by parts divided in the axial direction of the input shaft.

(2d) The functions of one component in the above embodiment may be distributed as a plurality of components, or the functions of a plurality of components may be integrated into one component. Part of the configuration of the above embodiments may be omitted. At least part of the configuration of the above embodiments may be added to or replaced with the configuration of another above embodiment. Note that all aspects comprised in the technical idea identified from the wording described in the claims are embodiments of the present disclosure.

1. A transmission device comprising:
a transmission mechanism having an input shaft;
a parking lock mechanism; and
a gear case that accommodates the transmission mechanism and the parking lock mechanism, wherein
the parking lock mechanism includes
a pawl shaft having a shaft center parallel to a rotation shaft center of the input shaft, and
a parking pawl swingable about the pawl shaft between a locked position, at which the parking pawl is engaged with the input shaft to restrict rotation of the input shaft, and an unlocked position, at which the parking pawl is disengaged from the input shaft,
the gear case includes
a first support portion that supports a first end portion of the pawl shaft, and
a second support portion that supports a second end portion of the pawl shaft opposite to the first end portion, the second support portion having higher rigidity against a lock load received from the parking pawl when the parking pawl is at the locked position than the first support portion does,
the pawl shaft has a communication hole reaching from an end face of the first end portion to an end face of the second end portion,
the first support portion is in contact with the first end portion over an entire circumferential direction, and
the second support portion includes
an insertion port, into which the second end portion is inserted,
a bottom face facing an end face of the second end portion in an axial direction of the pawl shaft, and
a groove extending from the bottom face to the insertion port.

2. The transmission device according to claim 1, wherein a straight line connecting a shaft center of the pawl shaft and a center of the groove intersects with a direction of the lock load when viewed in an axial direction of the pawl shaft.

3. The transmission device according to claim 1, wherein
the parking lock mechanism includes a torsion spring that is wound around the pawl shaft and that biases the parking pawl toward the unlocked position,
the torsion spring is disposed on a side opposite to the first support portion with the parking pawl interposed therebetween, and
the first support portion includes
a boss protruding from an inner face of the gear case, and
a collar inserted inside the boss.

4. The transmission device according to claim 2, wherein
the parking lock mechanism includes a torsion spring that is wound around the pawl shaft and that biases the parking pawl toward the unlocked position,
the torsion spring is disposed on a side opposite to the first support portion with the parking pawl interposed therebetween, and
the first support portion includes
a boss protruding from an inner face of the gear case, and
a collar inserted inside the boss.
